(19) United States
(12) Patent Application Publication
(10) Pub. No.: US 2026/0185916 A1
(43) Pub. Date: Jul. 2, 2026

(54) MAGNETIC PARTICULATE IMAGING DEVICE

(71) Applicant: Mitsubishi Electric Corporation, Tokyo (JP)

(72) Inventors: Kota NOMURA, Chiyoda-ku, Tokyo (JP); Tetsuya MATSUDA, Chiyoda-ku, Tokyo (JP); Masaomi WASHINO, Chiyoda-ku, Tokyo (JP)

(73) Assignee: Mitsubishi Electric Corporation, Tokyo (JP)

(21) Appl. No.: 18/867,812

(22) PCT Filed: May 29, 2023
(86) PCT No.: PCT/JP2023/019885

§ 371 Date: Nov. 21, 2024

(30) Foreign Application Priority Data
May 30, 2022 (JP) 2022-087523

(51) Int. Cl. G01N 15/06

(52) U.S. Cl. CPC G01N 15/0656

(57) ABSTRACT

A winding frame holds the AC magnetic field applying coil. The first skin thickness is determined by the frequency of a third harmonic wave of the AC magnetic field excited by the AC magnetic field applying coil and an electrical conductivity and a magnetic permeability of the winding frame. The second skin thickness is determined by the frequency of a fundamental wave of the AC magnetic field excited by the AC magnetic field applying coil and the electrical conductivity and the magnetic permeability of the winding frame.

### TECHNICAL FIELD

The present disclosure relates to a magnetic particulate imaging device.

### BACKGROUND ART

There is known a magnetic particulate detection device equipped with an AC magnetic field applying coil and a DC magnetic field applying unit (see, for example, PTL 1). Since only the magnetic particulates around a zero magnetic field region generated by the DC magnetic field applying unit are magnetized by an excitation field, the distribution information of the magnetic particulates can be obtained by scanning the relative position between the zero magnetic field region and the magnetic particulates. The imaging of the magnetic particulates is performed by scanning the zero magnetic field region to obtain the distribution of the magnetic particulates contained in a specimen. The magnetic particulate detection device of PTL 1 suppresses a fundamental wave component of a signal output from a measurement coil configured to detect a magnetic field, and extracts only a harmonic wave component.

### CITATION LIST

### Patent Literature

PTL 1: Japanese Patent Laying-Open No. 2003-199767

### SUMMARY OF INVENTION

### Technical Problem

In the magnetic particulate imaging device described in PTL 1, not only the fundamental wave current but also the harmonic wave current flow through the AC magnetic field applying coil due to the characteristics of an AC power supply connected thereto. As a result, the excited AC magnetic field also contains a harmonic wave. Therefore, the measurement coil simultaneously measures the harmonic wave output from the magnetic particulates and the harmonic wave excited by the AC magnetic field applying coil. Since the measurement coil cannot measure only the harmonic wave output from the magnetic particulates to be inspected, the detection accuracy of the magnetic particulates is degraded.

Therefore, an object of the present disclosure is to provide a magnetic particulate imaging device having a higher detection accuracy than a conventional device.

### Solution to Problem

A magnetic particulate imaging device according to the present disclosure is a magnetic particulate imaging device to determine a spatial distribution of magnetic particulates in a specimen arranged in an inspection region, and the magnetic particulate imaging device includes an AC magnetic field applying coil to generate an AC magnetic field that changes the magnetism of the magnetic particulates, a winding frame to hold the AC magnetic field applying coil, a DC magnetic field applicator to generate a region having a low magnetic field strength so as to change only the magnetism of the magnetic particulates in an arbitrary area of the specimen, and a measurement coil to detect a magnetism change of the magnetic particulates. At least one of a radial thickness of a hollow cylinder of the winding frame and a thickness of a flange of the winding frame is greater than or equal to a first skin thickness and less than or equal to a second skin thickness. The first skin thickness is determined by a frequency of a third harmonic wave of the AC magnetic field excited by the AC magnetic field applying coil, and an electrical conductivity and a magnetic permeability of the winding frame. The second skin thickness is determined by a frequency of a fundamental wave of the AC magnetic field excited by the AC magnetic field applying coil, and the electrical conductivity and the magnetic permeability of the winding frame.

### Advantageous Effects of Invention

Since at least one of the radial thickness of the hollow cylinder of the winding frame and the thickness of the flange of the winding frame is equal to or greater than the first skin thickness and equal to or less than the second skin thickness, the magnetic particulate imaging device of the present disclosure has a higher detection accuracy than a conventional device.

### BRIEF DESCRIPTION OF DRAWINGS

FIG. 1 is an XZ cross-sectional view of an AC magnetic field applying coil 3, a winding frame 6, measurement coils 4a and 4b, and a specimen 2 included in a magnetic particulate imaging device according to a first embodiment;

FIG. 2 is a view of the winding frame 6 and the measurement coils 4a and 4b included in the magnetic particulate imaging device according to the first embodiment as viewed from the X-axis direction;

FIG. 3 is a view of the winding frame 6 and the AC magnetic field applying coil 3 included in the magnetic particulate imaging device according to the first embodiment as viewed from the Y-axis direction;

FIG. 4 is a diagram schematically illustrating the structure of the winding frame 6 included in the magnetic particulate imaging device according to the first embodiment;

FIG. 5 is a diagram illustrating a process of detecting a magnetic field from magnetic particulates 1;

FIG. 6 is an XZ cross-sectional view of an AC magnetic field applying coil 3, a winding frame 6, measurement coils 4a and 4b, a shield 7, and a specimen 2 included in a magnetic particulate imaging device according to a second embodiment;

FIG. 7 is a view of the winding frame 6, the shield 7, and the measurement coils 4a and 4b included in the magnetic particulate imaging device according to the second embodiment as viewed from the X-axis direction;

FIG. 8 is an XZ cross-sectional view of the winding frame 6, the shield 7, and the AC magnetic field applying coil 3 included in the magnetic particulate imaging device according to the second embodiment; and

FIG. 9 is a view of a winding frame 6, a heat sink 8, and measurement coils 4a and 4b included in a magnetic particulate imaging device according to a third embodiment as viewed from the X-axis direction.

### DESCRIPTION OF EMBODIMENTS

Embodiments will be described with reference to the drawings.

### First Embodiment

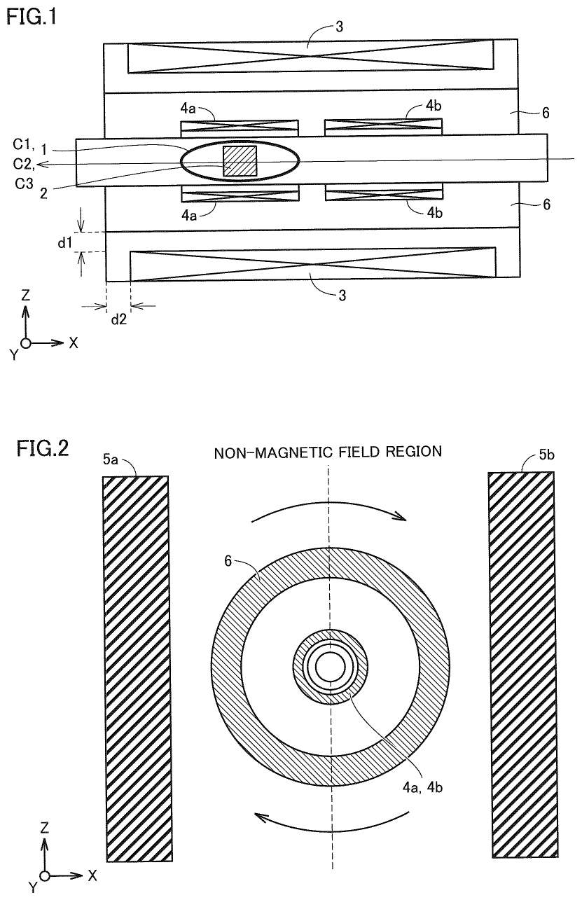

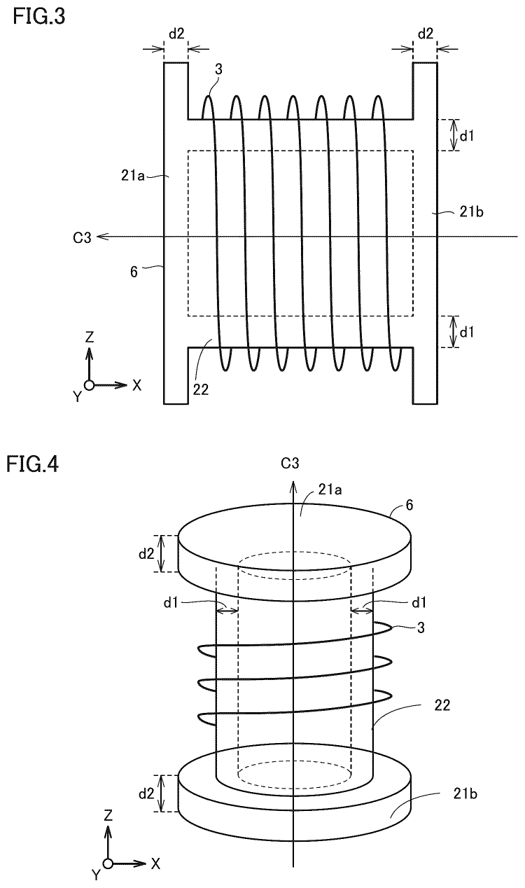

FIG. 1 is an XZ cross-sectional view of an AC magnetic field applying coil 3, a winding frame 6, measurement coils 4a and 4b, and a specimen 2 included in a magnetic particulate imaging device according to a first embodiment. FIG. 2 is a view of the winding frame 6 and the measurement coils 4a and 4b included in the magnetic particulate imaging device according to the first embodiment as viewed from the X-axis direction. FIG. 3 is a view of the winding frame 6 and the AC magnetic field applying coil 3 included in the magnetic particulate imaging device according to the first embodiment as viewed from the Y-axis direction. FIG. 4 is a diagram schematically illustrating the structure of the winding frame 6 included in the magnetic particulate imaging device according to the first embodiment.

The magnetic particulate imaging device determines a spatial distribution of magnetic particulates 1 in the specimen 2 arranged in an inspection region. The magnetic particulate imaging device includes an AC magnetic field applying coil 3, a winding frame 6, and measurement coils 4a and 4b.

DC magnetic field applicators 5a and 5b generate a non-magnetic field region having a low magnetic field strength so as to change only the magnetism of the magnetic particulates in an arbitrary area of the specimen 2.

The DC magnetic field applicators 5a and 5b generate a linear near-zero magnetic field region FFL (Field Free Line) so as to change the magnetism of the magnetic particulates 1 contained in the specimen 2. The DC magnetic field applicators 5a and 5b generate a linear near-zero magnetic field region FFL in an imaging region where the specimen 2 is arranged. Specifically, the DC magnetic field applicators 5a and 5b are composed of two permanent magnets which are arranged opposite to each other and the magnetization directions thereof are opposed to each other. Alternatively, the DC magnetic field applicators 5a and 5b may be two permanent magnets with yokes whose magnetizations are made opposite to each other by the yokes, or two electromagnets. The line direction of the linear near-zero magnetic field region FFL generated by the DC magnetic field applicators 5a and 5b is in the Y-axis direction.

The measurement coils 4a and 4b measure a magnetism change of the magnetic particulates. The direction of a central axis C1 of the measurement coil 4a and the direction of a central axis C2 of the measurement coil 4b are in the X-axis direction. The measurement coils 4a and 4b are disposed so as to sandwich the magnetic particulates 1 and the specimen 2 including the magnetic particulates 1.

The AC magnetic field applying coil 3 generates an AC magnetic field that changes the magnetism of the magnetic particulates 1. The AC magnetic field applying coil 3 is disposed so as to sandwich the magnetic particulates 1, the specimen 2, and the measurement coils 4a and 4b. The AC magnetic field applying coil 3 excites an AC magnetic field in an imaging region where the specimen 2 is arranged. The AC magnetic field applying coil 3 is connected to an AC power supply (not shown). The direction of a central axis C3 of the AC magnetic field applying coil 3 is in the X-axis direction. The central axis C3 coincides with the central axis C1 and the central axis C2.

The winding frame 6 holds the AC magnetic field applying coil 3. The winding frame 6 is constituted by a bobbin. The winding frame 6 includes a flange 21 a, a flange 21 b, and a hollow cylinder 22. The AC magnetic field applying coil 3 is wound around the hollow cylinder 22. The central axis of the hollow cylinder 22 coincides with the central axis C3 of the AC magnetic field applying coil 3. The flange 21 a and the flange 21 b are attached to both ends of the hollow cylinder 22, respectively.

The thickness of each of the flanges 21 a and 21 b is represented by d2. The radial thickness of the hollow cylinder 22 is represented by d1. In other words, the difference between the outer diameter and the inner diameter of the hollow cylinder 22 is d1.

The imaging of the magnetic particulates is performed by changing the relative position of the linear near-zero magnetic field region FFL generated by the DC magnetic field applicators 5a and 5b with respect to the specimen 2 and scanning the measurement positions. The relative position can be changed by mechanically moving the positions of the DC magnetic field applying devices 5a and 5b, the AC magnetic field applying coil 3, and the measurement coils 4a and 4b.

FIG. 5 is a diagram illustrating a process of detecting a magnetic field from the magnetic particulates 1.

The AC magnetic field applying coil 3 generates an AC magnetic field that changes the magnetization of the magnetic particulates 1. When the main frequency of the AC magnetic field is defined as a fundamental frequency fl (Hz), a magnetization change is generated in the magnetic particulates 1 by the AC magnetic field of the fundamental frequency fl (Hz) based on the magnetic field magnetization curve.

The magnetic field magnetization curve of the magnetic particulates 1 exhibits a nonlinear behavior when it includes magnetic saturation due to a saturation magnetic field. When superparamagnetic magnetic particulates having a small hysteresis are selected as the magnetic particulates 1, the magnetization change includes many odd-order harmonic waves.

A signal processing device connected to the measurement coils 4a and 4b extracts odd-order harmonic waves other than the fundamental wave of the fundamental frequency (fl) by filtering or the like. The frequencies of the odd-order harmonic waves are f3, f5, f7, and f9 represented by the following equations. As a result, it is possible to extract only the signal caused by the magnetic particulates 1 without being affected by the signal caused by the fundamental frequency fl of the AC magnetic field from the AC magnetic field applying coil 3

$$f 3 = 3 \times f 1 \qquad ( 1 a )$$

$$f 5 = 5 \times f 1 \qquad ( 1 b )$$

$$f 7 = 7 \times f 1 \qquad ( 1 c )$$

$$f 9 = 9 \times f 1 \qquad ( 1 d )$$

However, in the case where the AC power supply that supplies a current to the AC magnetic field applying coil 3 is, for example, a switching power supply, due to the characteristics of the switching element or the like, a harmonic wave component of the fundamental frequency fl (Hz) flows through the AC magnetic field applying coil 3. When evaluating a signal or the like from the magnetic particulates 1 in a living body, an AC magnetic field X of a harmonic wave component caused by the AC power supply is superimposed on an AC magnetic field Y caused by the magnetization change in the magnetic particulates 1. As a result, the signal-to-noise ratio (SNR) deteriorates and the frequency characteristics of the AC magnetic field X and the AC magnetic field Y match each other, which makes it difficult to extract only the signal from the magnetic particulates 1.

As described above, due to the AC power supply, the AC magnetic field applying coil 3 radiates not only a magnetic field of the fundamental frequency fl but also a magnetic field of an odd-order harmonic wave equal to or higher than a third-order harmonic wave.

In order to prevent the measurement coils 4a and 4b from measuring the magnetic field of the harmonic wave component generated by the AC magnetic field applying coil 3, it is required to determine the material and thickness of the winding frame 6 that holds the AC magnetic field applying coil 3. Specifically, the harmonic wave component of the AC magnetic field is absorbed by an eddy current generated in the winding frame 6, which thereby attenuates the harmonic wave component of the AC magnetic field interlinked to the measurement coils 4a and 4b.

It is known that an eddy current is generated in a region of a skin thickness 8 which is determined by a frequency f of the AC magnetic field, and an electrical conductivity α and a magnetic permeability μ of the specimen by the following equation. In the equation, μr represents the relative permeability of the specimen, and μ0 represents the magnetic permeability of vacuum,

$$[ Math . 1 ]$$

$$μ = μ r \times μ 0 \qquad ( 2 a )$$

$$O = \overline{\overline{nxf}} \overline{\overline{{}_{μ} xo}} \qquad ( 2 b )$$

In general, a magnetic shield for shielding noise can be made thicker than the skin thickness 8 in the equation (2b) to obtain sufficient magnetic shielding effect. If the magnetic shield is thinner than the skin thickness 8 of the equation (2b), the shield effect by the eddy current is not sufficient, and thereby unshielded components pass through the magnetic shield.

In the present embodiment, the AC magnetic field of the fundamental frequency fl is transmitted through the winding frame 6 so as to produce a magnetization change in the magnetic particulates 1, and the AC magnetic field of an odd-order harmonic wave equal to or higher than the third-order harmonic wave, which is necessary for evaluating the magnetization change in the magnetic particulates 1, is shielded by the winding frame 6.

The first skin thickness 83a is determined by a frequency f3 of the third harmonic wave of the AC magnetic field excited by the AC magnetic field applying coil 3, an electrical conductivity αa of the winding frame 6, and a magnetic permeability μa of the winding frame 6. The second skin thickness 81a is determined by the frequency fl of the fundamental wave of the AC magnetic field excited by the AC magnetic field applying coil 3, the electrical conductivity αa of the winding frame 6, and the magnetic permeability μa of the winding frame 6. Specifically, the second skin thickness 81a and the first skin thickness 83a are expressed by the following equations. In the equation, par represents the relative permeability of the winding frame 6, and μ0 represents the magnetic permeability of vacuum.

$$μ a = μ ar \times u 0 \qquad ( 3 a )$$

$$[ Math . 2 ]$$

$$o 1 a = - \frac{1}{n \times f 1 \times μ a \times α a} \qquad ( 3 b )$$

$$83 b = \frac{1}{n \times f 3 \times μ a \times α a} \qquad ( 3 c )$$

The thicknesses d1 and d2 of the winding frame 6 are designed to satisfy the following equations.

$$83 a \text{:} S d 1 \text{:} Sola \qquad ( 4 )$$

$$83 a \text{:} S d 2 \text{:} S 81 a \qquad ( 5 )$$

As a result, among the components of the AC magnetic field from the AC magnetic field applying coil 3, the winding frame 6 allows the component of the fundamental frequency fl to pass therethrough, and shields the magnetic field component of the third harmonic wave or higher. The component of the fundamental frequency fl is incident on the measurement coils 4a and 4b and the magnetic particulates 1.

Due to the AC magnetic field, a signal is generated according to the magnetization magnetic field curve depending on the material of the winding frame 6. Therefore, in addition to the conditions of the equations (4) and (5), a non-magnetic material such as aluminum or copper may be used as the material of the winding frame 6.

At least one of the equations (4) and (5) may be satisfied. Even when only one of the equations (4) and (5) is satisfied, the detection accuracy of the magnetic particulates is improved as compared with a conventional device.

### Second Embodiment

In the first embodiment, the thickness and the material of the winding frame 6 are determined based on the fundamental frequency fl of the AC magnetic field excited by the AC magnetic field applying coil 3 and the frequency f3 of the third harmonic wave so as to shield the harmonic wave component caused by the AC power supply, which makes it possible to improve the SNR. In the present embodiment, a magnetic shield is provided on the entire surface so as to surround not only the winding frame 6 but also the AC magnetic field applying coil 3.

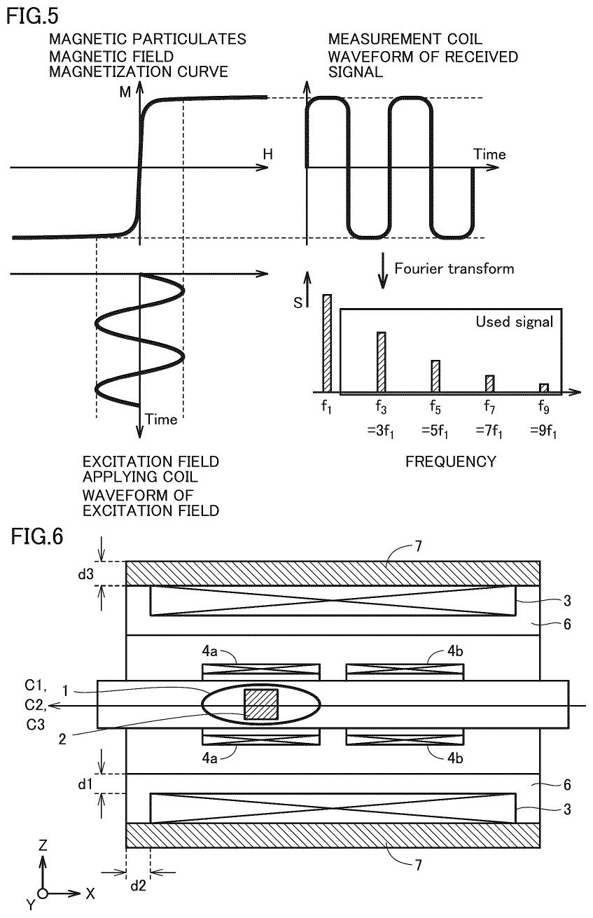

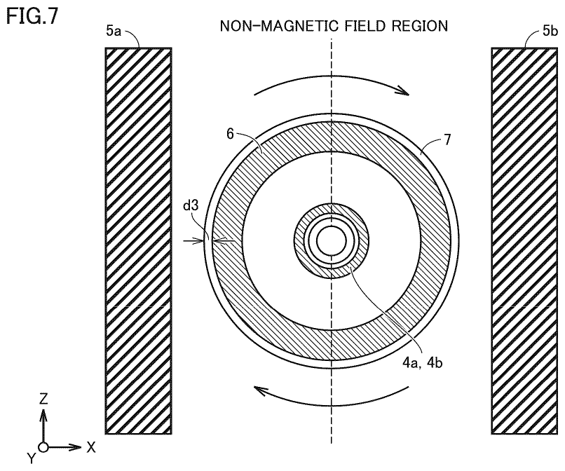

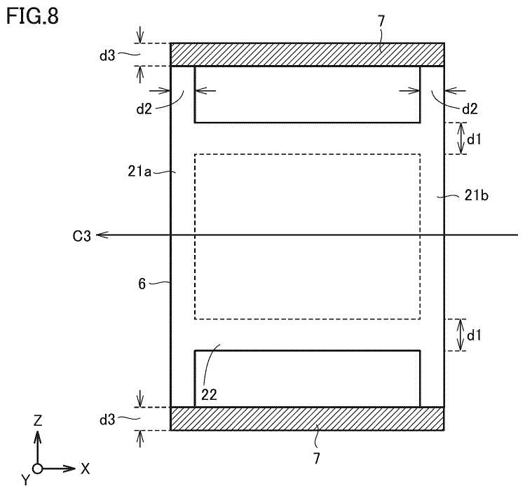

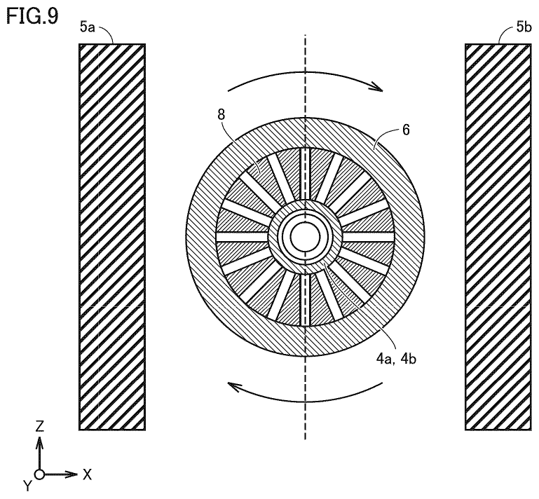

FIG. 6 is an XZ cross-sectional view of an AC magnetic field applying coil 3, a winding frame 6, measurement coils 4a and 4b, a shield 7, and a specimen 2 included in a magnetic particulate imaging device according to a second embodiment. FIG. 7 is a view of the winding frame 6, the shield 7, and the measurement coils 4a and 4b included in the magnetic particulate imaging device according to the second embodiment as viewed from the X-axis direction. FIG. 8 is an XZ cross-sectional view of the winding frame 6, the shield 7, and the AC magnetic field applying coil 3 included in the magnetic particulate imaging device according to the second embodiment.

An outer peripheral portion of the AC magnetic field applying coil 3 cannot be covered by the winding frame 6 due to factors in the process of manufacturing windings. As illustrated in FIGS. 6 to 8, a shield 7 is provided at the outer peripheral portion of the AC magnetic field applying coil 3, which cannot be covered by the winding frame 6.

The shield 7 is joined to both flanges of the winding frame 6, and is configured to seal the AC magnetic field applying coil 3. The AC magnetic field applying coil 3 is disposed in a sealed space formed by the winding frame 6 and the shield 7. The shield 7 has the shape of a hollow cylinder. The central axis of the shield 7 coincides with the central axis C3 of the AC magnetic field applying coil 3.

The third skin thickness 83b is determined by a frequency f3 of the third harmonic wave of the AC magnetic field excited by the AC magnetic field applying coil 3, an electrical conductivity αb of the shield 7, and a magnetic permeability μb of the shield. The fourth skin thickness 81 b is determined by the frequency fl of the fundamental wave of the AC magnetic field excited by the AC magnetic field applying coil 3, the electrical conductivity αb of the shield 7, and the magnetic permeability μb of the shield 7. Specifically, the fourth skin thickness 81 b and the third skin thickness 83b are expressed by the following equations. In the equation, μbr represents the relative permeability of the shield 7, and μ0 represents the magnetic permeability of vacuum.

$$μ b = μbr \times μ0 \qquad ( 6 a )$$

$$[ Math . 3 ]$$

$$81 b = \frac{1}{nxf 1 \times μ b \times π b} \qquad ( 6 b )$$

$$83 b = \frac{1}{nxf 3 \times μ b \times π b} \qquad ( 6 c )$$

The thickness d3 of the shield 7 is designed to satisfy the following the equation,

$$83 b \text{:} S d 3 \text{:} S 81 b \qquad ( 7 )$$

As a result, among the components of the AC magnetic field from the AC magnetic field applying coil 3, the shield 7 allows the component of the fundamental frequency fl to pass therethrough, and shields the magnetic field component of the third harmonic wave or higher.

Further, in terms of manufacturing management and magnetic effect management, the shield 7 and the winding frame 6 may be made of the same material.

In the present embodiment, by providing the shield, it is possible to further increase the detection accuracy of the magnetic particulates as compared with the first embodiment.

### Third Embodiment

The AC magnetic field applying coil 3 generates heat due to the AC loss and resistance heat caused by the AC magnetic field. When the electrical characteristics of the AC magnetic field applying coil 3 change due to the temperature change thereof, a perturbation occurs in the excitation field, which in turn causes a perturbation in the signal of imaging the magnetic particulates. The heat generated by the AC magnetic field applying coil 3 is also transmitted to the measurement coils 4a and 4b and the specimen 2 arranged inside the measurement coils 4a and 4b. As a result, the detection accuracy of the magnetic particulates 1 is degraded.

The winding frame 6 has a high thermal electrical conductivity since the material thereof is selected to have a high electrical conductivity for magnetic shielding. Thus, the winding frame 6 may be used as a heat sink to assist heat dissipation, which makes it possible to suppress heat rise and reduce noise. However, in order to improve the heat dissipation efficiency, it is necessary to change the thickness of the heat sink according to thermal design such as lengthening a heat dissipation groove in the heat sink, which results in a trade-off with the dimension determined by the skin thickness described in the above embodiment.

FIG. 9 is a view of the winding frame 6, the heat sink &, and the measurement coils 4a and 4b included in the magnetic particulate imaging device according to the third embodiment as viewed from the X-axis direction.

The magnetic particulate imaging device of the present embodiment includes a heat sink 8 connected to an inner surface of the hollow cylinder 22 of the winding frame 6.

The heat sink 8 is provided with a groove extending along the axial direction (X direction) of the AC magnetic field applying coil 3.

A longitudinal direction (X-axis direction) of the heat sink 8 and a current direction of the AC magnetic field applying coil 3 are orthogonal to each other. Since the eddy current flows in a direction parallel to the current direction of the AC magnetic field applying coil, the influence of the eddy current can be drastically reduced by the heat sink 8. As a result, the trade-off mentioned above can be resolved. In addition, by providing a groove in the axial direction (X-axis direction) of the AC magnetic field applying coil 3, a cooling solvent such as air can also pass through the heat sink 8 from the outside, which makes it possible to achieve a sufficient cooling effect.

It should be understood that the embodiments disclosed herein are illustrative and non-restrictive in all respects. The scope of the present invention is defined by the terms of the claims rather than the description of the embodiments above, and is intended to include any modifications within the scope and meaning equivalent to the terms of the claims.

### REFERENCE SIGNS LIST

1: magnetic particulate; 2: specimen; 3: AC magnetic field applying coil; 4a, 4b; measurement coil; 5a, 5b: DC magnetic field applicator; & winding frame; 7; shield; & heat sink; 21a, 21b; flange; 22: hollow cylinder.

1. A magnetic particulate imaging device to determine a spatial distribution of magnetic particulates in a specimen arranged in an inspection region, the magnetic particulate imaging device comprising:
an AC magnetic field applying coil to generate an AC magnetic field that changes the magnetism of the magnetic particulates;
a winding frame to hold the AC magnetic field applying coil;
a DC magnetic field applicator to generate a region having a low magnetic field strength so as to change only the magnetism of the magnetic particulates in an arbitrary area of the specimen; and
a measurement coil to detect a magnetism change of the magnetic particulates,
wherein at least one of a radial thickness of a hollow cylinder of the winding frame and a thickness of a flange of the winding frame is greater than or equal to a first skin thickness and less than or equal to a second skin thickness,
the first skin thickness is determined by a frequency of a third harmonic wave of the AC magnetic field excited by the AC magnetic field applying coil, and an electrical conductivity and a magnetic permeability of the winding frame, and
the second skin thickness is determined by a frequency of a fundamental wave of the AC magnetic field excited by the AC magnetic field applying coil, and the electrical conductivity and the magnetic permeability of the winding frame.

2. The magnetic particulate imaging device according to claim 1, wherein
both the radial thickness of the hollow cylinder of the winding frame and the thickness of the flange of the winding frame are greater than or equal to the first skin thickness and less than or equal to the second skin thickness.

3. The magnetic particulate imaging device according to claim 1, wherein
the winding frame is made of a non-magnetic material.

4. The magnetic particulate imaging device according to claim 1, further comprising:
a shield joined to the flange of the winding frame and configured to seal the AC magnetic field applying coil,
wherein a thickness of the shield is greater than or equal to a third skin thickness and less than or equal to a fourth skin thickness,
the third skin thickness is determined by a frequency of the third harmonic wave of the AC magnetic field, and an electrical conductivity and a magnetic permeability of the shield, and
the fourth skin thickness is determined by a frequency of the fundamental wave of the AC magnetic field, and the electrical conductivity and the magnetic permeability of the shield.

5. The magnetic particulate imaging device according to claim 4, wherein
the shield has a hollow cylindrical shape, and
a central axis of the shield coincides with a central axis of the AC magnetic field applying coil.

6. The magnetic particulate imaging device according to claim 4, wherein
the winding frame and the shield are made of the same material.

7. The magnetic particulate imaging device according to claim 1, further comprising:
a heat sink provided with a groove extending along an axial direction of the AC magnetic field applying coil.

8. The magnetic particulate imaging device according to claim 7, wherein
the heat sink is connected to an inner surface of the hollow cylinder of the winding frame

9. The magnetic particulate imaging device according to claim 7, wherein
a longitudinal direction of the heat sink and a current direction of the AC magnetic field applying coil are orthogonal to each other.
